(19) United States
(12) Patent Application Publication
(10) Pub. No.: US 2013/0143732 A1
(43) Pub. Date: Jun. 6, 2013

(54) EXHAUST GAS PURIFYING CATALYST

(71) Applicant: Yuki AOKI, Toyota-shi (JP)

(72) Inventor: Yuki AOKI, Toyota-shi (JP)

(21) Appl. No.: 13/677,657

(22) Filed: Nov. 15, 2012

(30) Foreign Application Priority Data
Dec. 2, 2011 (JP) 2011-265175

(51) Int. Cl. B01J 23/63; B01J 23/10

(52) U.S. Cl. 502/304

(57) ABSTRACT

The object of the invention is to provide an exhaust gas purifying catalyst having a high oxygen storage capacity without changing the usage amount of the oxygen storage component. According to the present invention, the exhaust gas purifying catalyst containing (a) a ceria-zirconia composite oxide containing ceria in a higher amount than zirconia, (b) a ceria-zirconia composite oxide containing zirconia in a higher amount than ceria, and (c) a ceria-zirconia composite oxide having a pyrochlore-type regular array structure is provided. The exhaust gas purifying catalyst of the present invention has a higher oxygen storage capacity than conventional catalysts and is effective in reducing the amount of NOx emission.

### BACKGROUND OF THE INVENTION

1. Field of the Invention

The present invention relates to an exhaust gas purifying catalyst containing multiple composite oxides as an oxygen storage component.

2. Background Art

Exhaust gas emitted from an internal-combustion engine of an automobile or the like contains harmful gases such as carbon monoxide (CO), nitrogen oxides (NOx), and unburned hydrocarbon (HC). As an exhaust gas purifying catalyst (so-called three-way catalyst) for decomposing such harmful gases, a ceria-zirconia composite oxide and the like having an oxygen storage capacity (OSC) is used. A substance having an oxygen storage capacity (oxygen storage component) can control an air-fuel ratio (A/F) in a micro space by absorbing and releasing oxygen and can suppress a decrease in a purification rate due to variations in exhaust gas composition. In particular, it is preferable for an exhaust gas purifying catalyst to have a high oxygen storage capacity so as to suppress NOx emission, since NOx generated in a lean atmosphere is difficult to be reduced.

For example, JP Patent Publication (Kokai) No. 2009-084061 A discloses an exhaust gas purifying catalyst containing a ceria-zirconia composite oxide in which a pyrochlore-type regular array phase is formed by cerium ions and zirconium ions and which can exhibit a sufficiently superior oxygen storage capacity even after exposure to a high temperature over a long time.

As a matter of course, there is a limit to the amount of oxygen that can be stored in an oxygen storage component. In order to achieve a greater effect, it is necessary to increase the amount of the oxygen storage component used or to change a composition of the oxygen storage component (increasing of a concentration of CeO₂, for example). However, the increase in the oxygen storage component is unfavorable because exhaust resistance is increased to lead to power reduction of an engine. Furthermore, the change of the composition of the oxygen storage component is also unfavorable because of leading to increase an influence of poisoning. In order to provide an exhaust gas purifying catalyst having a high oxygen storage capacity without changing the usage amount of the oxygen storage component, an oxygen storage component capable of absorbing and releasing oxygen with higher efficiency is required.

### SUMMARY OF THE INVENTION

After reviewing the above-described problems, the present inventor discovered that a higher oxygen storage capacity can be achieved by using three ceria-zirconia composite oxides whose compositions and crystal structures are different from each other and NO emission can further be reduced. The scope of the invention is as follows.

(1) An exhaust gas purifying catalyst containing (a) a ceria-zirconia composite oxide containing ceria in a higher amount than zirconia, (b) a ceria-zirconia composite oxide containing zirconia in a higher amount than ceria, and (c) a ceria-zirconia composite oxide having a pyrochlore-type regular array structure.

(2) The exhaust gas purifying catalyst according to (1), in which both of a content of (a) and a content of (b) are higher than a content of (c).

(3) The exhaust gas purifying catalyst according to (1) or (2), in which the content of (c) is 1 to 30% by weight with respect to a total content of (a) to (c).

(4) The exhaust gas purifying catalyst according to any one of (1) to (3), further containing a platinum group noble metal, in which the total content of (a) to (c) is 100 to 150 parts by weight with respect to 1 part by weight of the platinum group noble metal.

The exhaust gas purifying catalyst of the present invention can have a higher oxygen storage capacity and can reduce NOx emission compared to the conventional catalysts by containing the three ceria-zirconia composite oxides whose compositions and crystal structures are different from each other.

This specification incorporates the content of the specification of Japanese Patent Application No. 2011-265175, for which priority is claimed to the present application.

### BRIEF DESCRIPTION OF THE DRAWING

FIG. 1 is a graph showing the result of engine bench evaluation of catalysts of Examples 1 to 3 and Comparative Examples 1 to 7.

### DETAILED DESCRIPTION OF THE PREFERRED EMBODIMENTS

The exhaust gas purifying catalyst of the present invention is characterize by comprising (a) a ceria-zirconia composite oxide containing ceria in a higher amount than zirconia, (b) a ceria-zirconia composite oxide containing zirconia in a higher amount than ceria, and (c) a ceria-zirconia composite oxide having a pyrochlore-type regular array structure.

“Containing ceria in a higher amount than zirconia” for the ceria-zirconia composite oxide (a) means that a weight ratio of ceria contained in the composite oxide is higher than a weight ratio of zirconia contained in the composite oxide. The ceria-zirconia composite oxide (a) containing ceria in a higher amount than zirconia can be obtained by setting the amount, in terms of ceria (CeO₂), of a raw material such as cerium nitrate higher than the amount, in terms of zirconia (ZrO₂), of a raw material such as zirconium oxynitrate at the time of manufacture. Preferably, the ratio by weight of ceria to zirconia present in the ceria-zirconia composite oxide (a) is within the range of 1.1:1 to 5:1, more specifically, 1.5:1 to 3:1,

On the other hand, “containing zirconia in a higher amount than ceria” in the ceria-zirconia composite oxide (b) means that the weight ratio of zirconia contained in the composite oxide is higher than the weight ratio of ceria contained in the composite oxide. The ceria-zirconia composite oxide (b) containing zirconia in a higher amount than ceria can he obtained by setting the amount, in terms of zirconia (ZrO₂), of a raw material such as zirconium oxynitrate higher than the amount, in terms of ceria (CeO₂), of a raw material such as ceria to zirconia in the ceria-zirconia composite oxide (b) is within the range of 1:1.1 to 1:5, more specifically, 1:1.5 to 1:3 by weight.

The ceria-zirconia composite oxides (a) and (b) of the present invention may further contain elements selected from rare earth elements other than cerium. Examples of the rare earth elements include scandium (Sc), yttrium (Y), lanthanum (La), praseodymium (Pr), neodymium (Nd), samarium (Sm), gadolinium (Gd), terbium (Tb), dysprosium (Dy), ytterbium (Yb), and lutetium (Lu). Among them, Y, La, and Pr are particularly preferred. Preferably, the rare earth elements are contained in the form of oxides (Y₂O₃, La₂O₃, Pr₆O₁₁ and the like). By adding the rare earth elements other than cerium, a lattice defect is introduced and oxygen storage performance can be increased.

When the ceria-zirconia composite oxides (a) and (b) of the present invention contain the element selected from the rare earth elements other than cerium, the content of the elements in terms of an oxide is preferably within the range of 1 to 20% by weight, in particular 5 to 15% by weight with respect to the total amount of the ceria-zirconia composite oxides because the oxygen storage capacity is not impaired in this range.

Preferably, the ceria-zirconia composite oxide (a) contains La₂O₃ and Pr₆O₁₁ in addition to ceria and zirconia. Preferably, La₂O₃ is contained in an amount within the range of 1 to 10% by weight, in particular 3 to 7% by weight with respect to the total amount of the ceria-zirconia composite oxides. Preferably, Pr₆O₁₁ is contained in an amount within the range of 1 to 10% by weight, in particular 3 to 7% by weight with respect to the total amount of the ceria-zirconia composite oxides. Preferably, the content of Pr₆Oₙ is higher than the content of La₂O₃, and the ratio thereof is in the range of La₂O₃: Pr₆O₁₁=2:8 to 4:6 by weight.

Preferably, the ceria-zirconia composite oxide b contains La₂O₃ and Y₂O₃ in addition to ceria and zirconia. Preferably, La₂O₃ is contained in an amount within the range of 1 to 10% by weight, in particular 3 to 7% by weight with respect to the total amount of the ceria-zirconia composite oxides. Preferably, Y₂O₃ is contained in an amount within the range of 1 to 10% by weight, in particular 3 to 7% by weight with respect to the total amount of the ceria-zirconia composite oxides. Preferably, the ratio of the content of La₂O₃ to the content of Y₂O₃ is in the range of La₂O₃: Y₂O₃=4:6 to 6:4 by weight.

“Having a pyrochlore-type regular array structure” for the ceria-zirconia composite oxide (c) means having a crystalline array structure for which an X-ray diffraction pattern using CuKα has peaks at 2θ angles of 14°, 28°, 37°, 44.5°, and 51°, respectively. Preferably, for the ceria-zirconia composite oxide (c), the content ratio of a pyrochlore-type regular arrayed crystalline phase to the total crystalline phase obtained from a peak intensity ratio of the X-ray diffraction pattern is 50 to 100%, in particular 80 to 100%. In addition, preferably, in the ceria-zirconia composite oxide (c), the content ratio of ceria to zirconia is ceria: zirconia=45:55 to 55:45, in particular 47:53 to 53:47 by a molar ratio. Preferably, the ceria-zirconia composite oxide (c) does not contain rare earth elements or the like other than ceria and zirconia. A preparation method of a ceria-zirconia composite oxide having a pyrochlore-type regular array structure is well known to those skilled in the art.

Preferably, in the exhaust gas purifying catalyst of the present invention, both of the content of the ceria-zirconia composite oxide (a) and the content of the ceria-zirconia composite oxide (b) are higher than the content of the ceria-zirconia composite oxide (c). Preferably, the content of the ceria-zirconia composite oxide (c) is within the range of 1 to 30% by weight, in particular 1 to 20% by weight with respect to the total content of the ceria-zirconia composite oxides (a) to (c). Furthermore, preferably, the content of the ceria-zirconia composite oxide (b) is higher than the content of the ceria-zirconia composite oxide (a) because a higher oxygen storage capacity can be obtained. When the ratio of the content of the ceria-zirconia composite oxide (a) to the content of the ceria-zirconia composite oxide (b) is a: b=1:2 to 1:3 by weight, a particularly high oxygen storage capacity can be obtained. For the exhaust gas purifying catalyst of the present invention, the most preferable content ratio of the ceria-zirconia composite oxides (a) to (c) is within the range of 25˜29:63˜67:6˜10, in particular 27:65:8 by weight.

Preferably, the exhaust gas purifying catalyst of the present invention further contains a platinum group noble metal as a main catalyst. Examples of the platinum group noble metal include ruthenium (Ru), rhodium (Rh), palladium (Pd), osmium (Os), iridium (Ir), and platinum (Pt), and in particular, it is preferable that Pt and Pd be used. Preferably, the platinum group noble metal is used for the exhaust gas purifying catalyst with supported by a support different from the ceria-zirconia composite oxides (a) to (c), for example, a lanthanum-added alumina support (La₂O₃/Al₂O₃). Preferably, in the exhaust gas purifying catalyst of the present invention, the platinum group noble metal is used in an amount within the range of 0.01 to 5.0 g/L, in particular 0.1 to 2.0 g/L. In addition, preferably, in the exhaust gas purifying catalyst of the present invention, the total content of the ceria-zirconia composite oxides (a) to (c) is within the range of 100 to 150 parts by weight, in particular 110 to 140 parts by weight with respect to 1 part by weight of the platinum group noble metal.

In the exhaust gas purifying catalyst of the present invention, a synergistic effect of improving an oxygen storage capacity, which is not expected from an oxygen storage capacity of each ceria-zirconia composite oxide, can be obtained by using a combination of the three ceria-zirconia composite oxides. Each of ceria-zirconia composite oxides is considered to be different in an oxygen absorbing/releasing rate based on a composition or a crystal structure. However, it is considered that, in the exhaust gas purifying catalyst of the present invention, the synergistic effect in the oxygen storage capacity can be obtained by combining the three ceria-zirconia composite oxides having oxygen absorbing/releasing rates different from each other due to different compositions and crystal structures. Furthermore, it is considered, in the exhaust gas purifying catalyst of the present invention, that lean NOx emission can be minimized in various situations by combining the three ceria-zirconia composite oxides having oxygen absorbing/releasing rates different from each other.

### EXAMPLES

Hereinafter, the present invention is described in further detail with reference to Examples. However, the present invention is not limited to the Examples.

1) Preparation of alumina-supported palladium catalyst

A support was impregnated with a palladium nitrate solution such that the rate of metal palladium is 1 g/L with respect to 40 g/L of a lanthanum-added alumina support (La₂O₃/Al₂O₃=4/96% by weight). The support was dried at 120° C. for 30 minutes, and then calcined at 500° C. for 2 hours to obtain an alumina-supported palladium catalyst.

2) Preparation of catalyst slurry

Three materials: “CZ material”, “ZC material”, and “pyrochlore CZ material” were used as oxygen storage components. The compositions of the respective materials are shown in Table 1.

TABLE 1

| | CeO₂ | ZrO₂ | La₂O₃ | Y₂O₃ | PrO₁₁ |
|---|---|---|---|---|---|
| CZ material | 60 | 30 | 3 | 0 | 7 |
| ZC material | 30 | 60 | 5 | 5 | 0 |
| Pyrochlore | 50 | 50 | 0 | 0 | 0 |
| CZ material | | | | | |

Unit: % by weight

“CZ material” indicates a ceria-zirconia composite oxide containing ceria in a higher amount than zirconia. “ZC material” indicates a ceria-zirconia composite oxide containing zirconia than in a higher amount ceria. Products commercially available from Rhodia Corporation were used for both of the “CZ material” and “ZC material”.

“Pyrochlore CZ material” indicates a ceria-zirconia composite oxide having the pyrochlore-type regular array structure. Preparation example thereof is described below.

49.1 g of a cerium nitrate aqueous solution having a concentration of 28% by weight in terms of CeO₂, 54.7 g of a zirconium oxynitrate aqueous solution having a concentration of 18% by weight in terms of ZrO₂, and a commercially available surfactant are dissolved in 90 mL of ion-exchange water. An ammonia solution having an NH₃ concentration of 25% by weight is added in 1.2 equivalent amounts in relation to anions to generate coprecipitates, and the coprecipitates are filtered off and washed. The obtained coprecipitates are dried at 110° C., and then calcined at 500° C. for 5 hours in the atmosphere to obtain a solid solution of cerium and zirconium. The obtained solid solution is pulverized with a pulverizer into particles having an average particle size of 1000 nm to obtain a ceria-zirconia solid solution powder that contains ceria and zirconia at a molar ratio (CeO₂:ZrO₂) of 50:50. After the obtained ceria-zirconia solid solution powder is filled in a polyethylene bag and air in the bag is evacuated, the bag is thermally sealed. The ceria-zirconia solid solution powder is molded under a pressure of 300 MPa for 1 minute by using a hydrostatic press machine to obtain a solid raw material of the ceria-zirconia solid solution powder. The obtained solid raw material is put into a graphite crucible, the crucible is covered with a graphite lid, and reduction is conducted at 1700° C. for 5 hours in an Ar gas. The sample after the reduction is pulverized with a pulverizer to obtain a powder having an average particle size of approximately 5 μm.

The oxygen storage component each compounded in the respective proportions in Table 2 below and the alumina-supported palladium catalyst (41 g/L) prepared in the above (1) were mixed with water and a binder (5 g/L), and the pH and viscosity were controlled using acetic acid or the like to obtain a catalyst slurry.

TABLE 2

| | | | Pyrochlore |
|---|---|---|---|
| | CZ material | ZC material | CZ material |
| Example 1 | 85 | 35 | 10 |
| Example 2 | 60 | 60 | 10 |
| Example 3 | 35 | 85 | 10 |
| Comparative Example 1 | 130 | 0 | 0 |
| Comparative Example 2 | 0 | 130 | 0 |
| Comparative Example 3 | 0 | 0 | 130 |
| Comparative Example 4 | 0 | 0 | 120 |
| Comparative Example 5 | 90 | 30 | 0 |
| Comparative Example 6 | 60 | 60 | 0 |
| Comparative Example 7 | 30 | 90 | 0 |

Unit (g/L)

3) Engine bench evaluation

The catalyst slurry obtained in (2) above was coated on an 875-cc monolith substrate, dried at 150° C., and then calcined at 500° C. to obtain an exhaust gas purifying catalyst. The obtained catalyst was evaluated for catalytic activity using an in-line four-cylinder engine as follows.

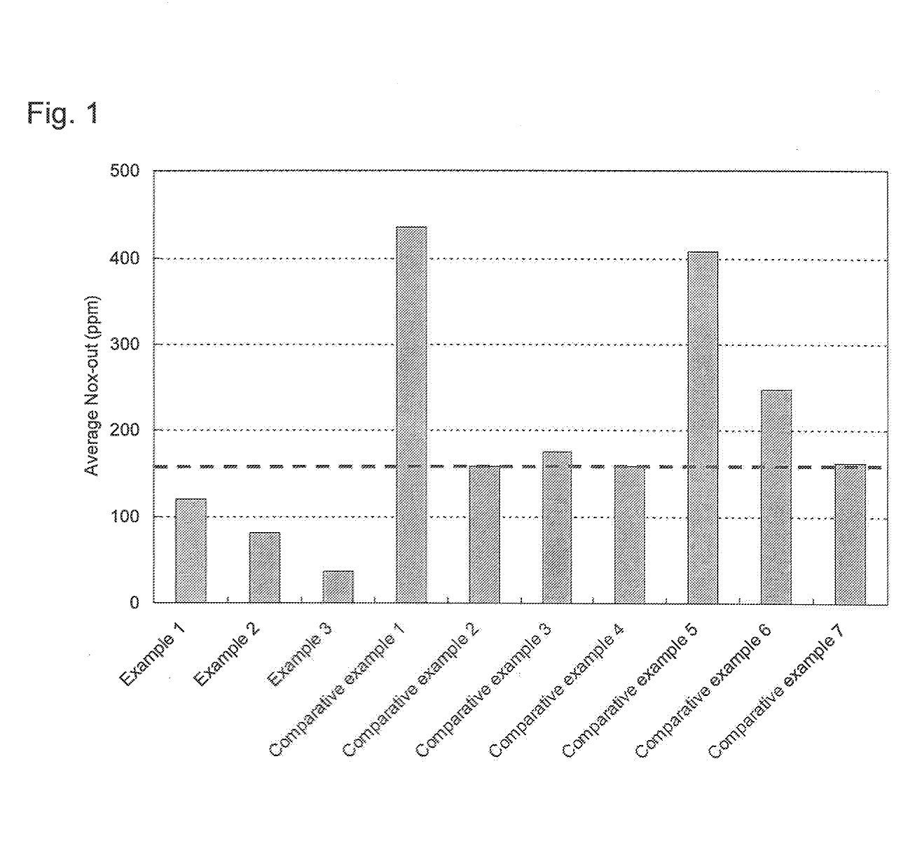

The catalyst was attached to the in-line four-cylinder engine (2400 cc, revolving speed 3000 rpm, intake air flow 35 g/sec). A combustion state of the engine was controlled such that the air-fuel ratio of catalyst inlet gas was between 14.0 and 14.8 (switching every 5 seconds) and the inlet gas temperature was 500° C., and exhaust gas emitted from the engine was made to flow in the catalyst. The results of measurement of a concentration of NOx in the catalyst outlet gas are shown in a graph in FIG. 1.

In Examples 1 to 3 that used a mixture of the three oxygen storage components, the amount of NOx emission was smaller than those in Comparative Examples 1 to 4 that used one oxygen storage component only and Comparative Examples 5 to 7 that used only two oxygen storage components. Among Examples 1 to 3, the amount of NOx emission was small especially in Example 3 containing ZC material in a higher amount than CZ material.

All references, including any publications, patents or patent applications cited in this specification are hereby incorporated by reference in their entirely.

What is claimed is:

1. An exhaust gas purifying catalyst comprising:
(a) a ceria-zirconia composite oxide comprising ceria in a higher amount than zirconia;
(b) a ceria-zirconia composite oxide comprising zirconia in a higher amount than ceria; and
c) a ceria-zirconia composite oxide having a pyrochlore-type regular array structure.

2. The exhaust as purifying catalyst according to claim 1, wherein both of a content of (a) and a content of (b) are higher than a content of (c).

3. The exhaust gas purifying catalyst according to claim 1, wherein the content of (c) is 1 to 30% by weight with respect to a total content of (a) to (c).

4. The exhaust gas purifying catalyst according to claim 2, wherein the content of (c) is 1 to 30% by weight with respect to a total content of (a) to (c).

5. The exhaust as purifying catalyst according to claim 1, further comprising a platinum group noble metal, wherein the total content of (a) to (c) is 100 to 150 parts by weight with respect to 1 part by weight of the platinum group noble metal.

6. The exhaust gas purifying catalyst according to claim 2, further comprising a platinum group noble metal, wherein the total content of (a) to (c) is 100 to 150 parts by weight with respect to 1 part by weight of the platinum group noble metal.

7. The exhaust gas purifying catalyst according to claim 3, further comprising a platinum group noble metal, wherein the total content of (a) to (c) is 100 to 150 parts by weight with respect to 1 part by weight of the platinum group noble metal.

8. The exhaust gas purifying catalyst according to claim 4, further comprising a platinum group noble metal, wherein the total content of (a) to (c) is 100 to 150 parts by weight with respect to 1 part by weight of the platinum group noble metal.
